(19) United States
(12) Patent Application Publication
(10) Pub. No.: US 2026/0073795 A1
(43) Pub. Date: Mar. 12, 2026

(54) ONCOMING TRAFFIC ALERT INFORMATION GENERATION, AND ONCOMING TRAFFIC ALERT METHOD, APPARATUS, MEDIUM, AND PRODUCT

(71) Applicant: AutoNavi Information Technology Co., Ltd., Beijing (CN)

(72) Inventors: Tao LIU, Beijing (CN); Fan ZUO, Beijing (CN); Feiyu LONG, Beijing (CN); Gang PAN, Beijing (CN); Mingzhi HUANG, Beijing (CN); Jian LIU, Beijing (CN); Aju LAN, Beijing (CN); Yu LIU, Beijing (CN)

(21) Appl. No.: 19/392,828

(22) Filed: Nov. 18, 2025

Related U.S. Application Data
(63) Continuation of application No. PCT/CN2024/078576, filed on Feb. 26, 2024.

(30) Foreign Application Priority Data
May 25, 2023 (CN) 202310605110.X

(51) Int. Cl. G08G 1/16; G08G 1/01; G08G 1/015; G08G 1/052

(52) U.S. Cl. CPC G08G 1/164; G08G 1/0112; G08G 1/0129; G08G 1/0133; G08G 1/0141; G08G 1/0145; G08G 1/015; G08G 1/052; G08G 1/166

(57) ABSTRACT

A method generating oncoming traffic alert information includes: acquiring real-time driving information of vehicles traveling on a target road that includes an accident-prone road segment; predicting trajectories of the vehicles when traveling on the accident-prone road segment, based at least on real-time driving information collected prior the vehicles enter the accident-prone road segment and road segment characteristics associated therewith; determining, based on the trajectories of vehicles driving in different traffic directions on the accident-prone road segment, a target vehicle that will have an oncoming traffic event on the accident-prone road segment and an oncoming traffic alert location; and transmitting oncoming traffic alert information carrying the oncoming traffic alert location and oncoming traffic warning message to a client device of the target vehicle, for the client device to alert the target vehicle that there is an oncoming vehicle on the accident-prone road segment.

### CROSS-REFERENCE TO RELATED APPLICATIONS

This application is a Continuation application of International Patent Application No. PCT/CN2024/078576, filed on Feb. 26, 2024, which is based on and claims priority to and benefits of Chinese Patent Application No. 202310605110.X, filed on May 25, 2023. The entire contents of the above-referenced applications are incorporated herein by reference.

### TECHNICAL FIELD

The present application relates to the field of travel technology, and specifically, to a generation of oncoming traffic alert information, and an oncoming traffic alert method, apparatus, medium, and product.

### BACKGROUND

As driving has become a high-frequency activity in daily life, vehicle ownership is continuously increasing. When there are many vehicles on the road, oncoming traffic is a situation that drivers often need to face. In accident-prone road segments such as sharp turns and narrow roads, which have blind spots or narrow road surfaces, if a vehicle enters the opposing lane or its speed is too fast during an oncoming traffic event, it can easily lead to a traffic accident.

In related technologies, in the aforementioned accident-prone road segments, drivers of vehicles typically use methods such as honking or changing lights to remind drivers of oncoming vehicles to drive according to regulations to avoid traffic accidents. However, this type of alert method is highly dependent on the driver's driving experience, and its effectiveness and timeliness are limited. Therefore, how to improve the effectiveness and timeliness of oncoming traffic alerts has become an urgent technical problem to be solved.

### SUMMARY

Embodiments of the present application provide an oncoming traffic alert information generation, and an oncoming traffic alert method, apparatus, medium, and product.

In a first aspect, an embodiment of the present application provides a method for generating oncoming traffic alert information.

Specifically, the method for generating oncoming traffic alert information includes:
acquiring real-time driving information from one or more vehicles traveling on a target road, wherein the real-time driving information for each vehicle comprises a real-time location and a real-time speed, and wherein the target road includes an accident-prone road segment that supports two-way traffic;
predicting, for each vehicle, a trajectory of the vehicle through the accident-prone road segment, based at least on the real-time driving information collected prior to the vehicle entering the accident-prone road segment and road segment characteristics associated therewith;
determining, based on the predicted trajectories of vehicles traveling in opposite directions along the accident-prone road segment, whether a first vehicle is predicted to encounter an oncoming second vehicle within the accident-prone road segment, and if so, identifying the first vehicle as a target vehicle and determining an oncoming traffic alert location located ahead of a predicted encounter point; and
transmitting, to a client device associated with the target vehicle, oncoming traffic alert information comprising the oncoming traffic alert location and an oncoming traffic warning message, such that the client device issues a warning to a driver of the target vehicle as it approaches the oncoming traffic alert location, indicating the presence of an oncoming vehicle within the accident-prone road segment.

In a second aspect, an embodiment of the present application provides an oncoming traffic alert method.

Specifically, the oncoming traffic alert method includes:
receiving oncoming traffic alert information, the oncoming traffic alert information carrying an oncoming traffic alert location and oncoming traffic warning message; and
outputting the oncoming traffic warning message when a target vehicle travels to the oncoming traffic alert location.

In a third aspect, an embodiment of the present application provides an apparatus for generating oncoming traffic alert information, including:
a real-time information acquisition module, configured to acquire real-time driving information of vehicles traveling on a target road, the real-time driving information including a real-time location and a real-time speed of the vehicles, the target road including an accident-prone road segment, and the accident-prone road segment being at least a two-way traffic road segment;
a trajectory prediction module, configured to predict trajectories of the vehicles when traveling on the accident-prone road segment based at least on the real-time driving information collected before the vehicles enter the accident-prone road segment and road segment characteristics associated therewith;
an oncoming traffic determination module, configured to determine, based on the trajectories of the vehicles traveling in different traffic directions on the accident-prone road segment, a target vehicle that will have an oncoming traffic event on the accident-prone road segment and an oncoming traffic alert location; and
an alert transmitting module, configured to send oncoming traffic alert information carrying the oncoming traffic alert location and oncoming traffic warning message to a client device associated with the target vehicle, for the client device to alert the target vehicle at the oncoming traffic alert location that there is an oncoming vehicle on the accident-prone road segment.

In a fourth aspect, an embodiment of the present application provides an oncoming traffic alert apparatus, including:
a receiving module, configured to receive oncoming traffic alert information, the oncoming traffic alert information carrying an oncoming traffic alert location and oncoming traffic warning message; and
an output module, configured to output the oncoming traffic warning message when a target vehicle travels to the oncoming traffic alert location.

In a fifth aspect, an embodiment of the present application provides an electronic device, including a memory and a processor, wherein the memory is configured to store one or more computer instructions, and wherein the one or more computer instructions are executed by the processor to implement the method according to any one of the first aspect or the second aspect.

In a sixth aspect, an embodiment of the present application provides a computer-readable storage medium, on which computer instructions are stored, wherein the computer instructions, when executed by a processor, implement the method according to any one of the first aspect or the second aspect.

In a seventh aspect, an embodiment of the present application provides a computer program product, including computer instructions, wherein the computer instructions, when executed by a processor, implement the method steps according to any one of the first aspect or the second aspect.

The technical solution provided by the embodiments of the present application may include the following beneficial effects:

The above technical solution can acquire real-time driving information of vehicles traveling on a target road that includes the accident-prone road segment, where the real-time driving information includes the real-time location and real-time speed of the vehicles. Then, based on the real-time driving information collected before the vehicles enter the accident-prone road segment and road segment characteristics associated therewith, the trajectories of the vehicles when traveling on the accident-prone road segment is predicted. In this way, based on the trajectories of vehicles traveling in different traffic directions on the accident-prone road segment, it is possible to determine a target vehicle that will have an oncoming traffic event on the accident-prone road segment and an oncoming traffic alert location. Subsequently, oncoming traffic alert information carrying the oncoming traffic alert location and oncoming traffic warning message is sent to a client device associated with the target vehicle, for the client device of the target vehicle to alert the target vehicle that it will have an oncoming traffic event with an oncoming vehicle at the accident-prone road segment, so that the driver of the target vehicle pays attention to the oncoming vehicle. Because embodiments of the present application predict vehicle driving trajectories in advance based on real-time driving information of vehicles and information of accident-prone road segments to predict oncoming traffic events in advance, it is possible to provide an oncoming traffic alert in advance to the driver of a target vehicle that is about to have an oncoming traffic event on an accident-prone road segment. Therefore, the effectiveness and timeliness of oncoming traffic alerts are improved, and the risk of oncoming traffic collisions on accident-prone road segments is reduced. In addition, even if there are blind spots on the accident-prone road segment, the solution of the embodiments of the present application can still predict vehicles with a possibility of an oncoming traffic event, reducing the risk of collisions with oncoming vehicles due to blind spots during driving.

It should be understood that the foregoing general description and the following detailed description are merely exemplary and explanatory and are not intended to limit the present application.

### BRIEF DESCRIPTION OF THE DRAWINGS

Through the detailed description of the following non-limiting embodiments in conjunction with the accompanying drawings, other features, objects, and advantages of the present application will become more apparent. In the drawings:

FIG. 1 shows a flowchart of a method for generating oncoming traffic alert information according to an embodiment of the present application;

FIG. 2 shows a flowchart of an oncoming traffic alert method according to an embodiment of the present application;

FIG. 3 shows a schematic diagram of an oncoming traffic alert output on a navigation screen according to an embodiment of the present application;

FIG. 4 shows a schematic diagram of an application in a navigation scenario according to an embodiment of the present application;

FIG. 5 shows a structural block diagram of an apparatus for generating oncoming traffic alert information according to an embodiment of the present application;

FIG. 6 shows a structural block diagram of an oncoming traffic alert apparatus according to an embodiment of the present application;

FIG. 7 shows a structural block diagram of an electronic device according to an embodiment of the present application;

FIG. 8 shows a schematic structural diagram of a computer system suitable for implementing the method according to an embodiment of the present application.

### DETAILED DESCRIPTION OF THE EMBODIMENTS

Hereinafter, exemplary embodiments of the present application will be described in detail with reference to the accompanying drawings so that they can be easily implemented by those skilled in the art. In addition, for the sake of clarity, parts irrelevant to the description of the exemplary embodiments are omitted in the drawings.

In the present application, it should be understood that terms such as “including” or “having” are intended to indicate the presence of the features, numbers, steps, actions, components, parts, or combinations thereof disclosed in this specification, and are not intended to exclude the possibility of the presence or addition of one or more other features, numbers, steps, actions, components, parts, or combinations thereof.

It also needs to be noted that, without conflict, the embodiments in the present application and the features in the embodiments can be combined with each other. The present application will be described in detail below with reference to the accompanying drawings and in conjunction with the embodiments.

As described above, in related technologies, in accident-prone road segments, drivers of vehicles typically use methods such as honking or changing lights to remind drivers of oncoming vehicles to drive according to regulations to avoid traffic accidents. However, this type of alert method is highly dependent on the driver's driving experience, and its effectiveness and timeliness are limited. Therefore, how to improve the effectiveness and timeliness of oncoming traffic alerts has become an urgent technical problem to be solved.

To solve the above technical problem, the present application provides a method for generating oncoming traffic alert information. The method can predict in advance a target vehicle that will have an oncoming traffic event on an accident-prone road segment and an oncoming traffic alert location based on real-time driving information collected before the vehicle enters the accident-prone road segment and road segment characteristics associated therewith, so that a client device associated with the target vehicle alerts the target vehicle that there is an oncoming vehicle on the accident-prone road segment. In this way, an oncoming traffic alert can be accurately provided in advance to the driver of a vehicle that is about to have an oncoming traffic event on an accident-prone road segment, improving the effectiveness and timeliness of the oncoming traffic alert and reducing the probability of oncoming traffic collisions on the accident-prone road segment.

FIG. 1 shows a flowchart of a method for generating oncoming traffic alert information according to an embodiment of the present application. As shown in FIG. 1, the method for generating oncoming traffic alert information includes the following steps S101-S104:

In step S101, acquiring real-time driving information of vehicles traveling on a target road, the real-time driving information including a real-time location and a real-time speed of the vehicles, the target road including an accident-prone road segment, and the accident-prone road segment being at least a two-way traffic road segment.

In step S102, predicting trajectories of the vehicles when traveling on the accident-prone road segment based at least on the real-time driving information collected before the vehicles enter the accident-prone road segment and road segment characteristics associated therewith.

In step S103, determining, based on the trajectories of the vehicles traveling in different traffic directions on the accident-prone road segment, a target vehicle that will have an oncoming traffic event on the accident-prone road segment and an oncoming traffic alert location.

In step S104, transmitting oncoming traffic alert information carrying the oncoming traffic alert location and oncoming traffic warning message to a client device associated with the target vehicle, for the client device to alert the target vehicle at the oncoming traffic alert location that there is an oncoming vehicle on the accident-prone road segment.

In a possible embodiment, the method for generating oncoming traffic alert information is applicable to devices that can execute the generation of oncoming traffic alert information, such as a computer, a computing device, a server, a server cluster, etc.

In a possible embodiment, the target road refers to a road that includes an accident-prone road segment. The accident-prone road segment refers to a two-way traffic road segment where accidents, especially oncoming traffic collision accidents, are prone to occur, such as two-way sharp turn road segments or road segments with a narrow road surface. On these road segments, vehicles are prone to encroaching on the opposing lane. The accident-prone road segment can be configured after assessment by professionals, or it can be automatically obtained by counting historical oncoming traffic accidents on various two-way traffic road segments. For example, a two-way traffic road segment where the frequency of historical oncoming traffic accidents is greater than a predetermined frequency can be determined as an accident-prone road segment.

In a possible embodiment, the real-time driving information of the vehicles traveling on the target road includes the real-time location and real-time speed of the vehicles. In some other embodiments, the real-time driving information also includes other real-time information such as historical driving trajectories. A client device of a vehicle can acquire a real-time positioning signal of the vehicle through a positioning chip on the vehicle, and obtain the real-time location of the vehicle (also can be called real-time location) based on the positioning signal. A series of real-time locations constitutes the driving trajectory of the vehicle. Further, the real-time speed of the vehicle can be calculated through the real-time location of the vehicle. Certainly, the real-time speed of the vehicle can also be acquired by the client device of the vehicle through a speed sensor on the vehicle and then reported by the client device. The various methods for acquiring the real-time driving information of the vehicle are known to those skilled in the art and are not exhaustively listed herein.

In a possible embodiment, the road segment characteristics may include any information that can affect the driving behavior of vehicles on the accident-prone road segment, which may include real-time environmental information and basic attribute information. The real-time environmental information of the road segment includes: real-time traffic conditions and/or road visibility. The basic attribute information includes: one or a combination of road segment width, road segment curvature, or roadside obstruction condition. The real-time traffic conditions refer to real-time traffic flow information of the accident-prone road segment, such as congested, clear, etc. The road visibility refers to the maximum distance at which the human eye can identify a target object on the accident-prone road segment. Road visibility is related to weather, the current time of day (daytime or nighttime), etc. For example, in weather conditions such as fog, smoke, sandstorms, heavy snow, drizzle, etc., visibility is low, and visibility at night is lower than during the day. The roadside obstruction condition refers to whether there are obstructions on both sides of the road causing blind spots and information on the size of the blind spot areas.

In a possible embodiment, the target vehicles that will have an oncoming traffic event on the accident-prone road segment are all vehicles that are about to pass through the accident-prone road segment. Therefore, dead reckoning technology can be used. Based on the real-time driving information collected before the vehicles enter the accident-prone road segment and the road segment characteristics associated therewith, dead reckoning is performed to predict the future trajectories of these vehicles that are about to pass through the accident-prone road segment when they travel on the accident-prone road segment. The trajectories include the location and time of future trajectory points of the vehicles on the accident-prone road segment.

In a possible embodiment, analysis and judgment can be performed based on the trajectories of the vehicles traveling in different traffic directions on the accident-prone road segment to determine the target vehicle that will have an oncoming traffic event on the accident-prone road segment and the oncoming traffic alert location for alerting this oncoming traffic event. Because the oncoming traffic event needs to be alerted in advance, the oncoming traffic alert location can be determined to be before the location where the oncoming traffic event occurs.

In a possible embodiment, when it is determined that a target vehicle will have an oncoming traffic event at an oncoming traffic alert location, oncoming traffic alert information carrying the oncoming traffic alert location and oncoming traffic warning message can be sent to a client device associated with the target vehicle, to remind the driver of the vehicle that he/she is about to have an oncoming traffic event with an oncoming vehicle at the oncoming traffic alert location on the accident-prone road segment. The driver of the vehicle will then drive carefully and according to regulations, pay attention to the oncoming vehicle, and reduce the probability of collision risk with the oncoming vehicle.

It should be noted here that a server will continuously perform steps S101-S104. As vehicles near the accident-prone road segment travel, the target vehicles that will have an oncoming traffic event on the accident-prone road segment will continuously change, and the target vehicle and the oncoming traffic alert location will be continuously updated and changed. Before the oncoming traffic event of the target vehicle occurs, the server will continuously update the oncoming traffic alert information to the client device of the target vehicle. When a new oncoming traffic event is identified, oncoming traffic alert information is sent to a client device of a target vehicle involved in the new event.

This embodiment can acquire real-time driving information of vehicles traveling on a target road that includes the accident-prone road segment, where the real-time driving information includes the real-time location and real-time speed of the vehicles. Then, based on the real-time driving information collected before the vehicles enter the accident-prone road segment and road segment characteristics associated therewith, the trajectories of the vehicles when traveling on the accident-prone road segment are predicted. In this way, based on the trajectories of vehicles traveling in different traffic directions on the accident-prone road segment, it is possible to determine a target vehicle that will have an oncoming traffic event on the accident-prone road segment and an oncoming traffic alert location. Subsequently, oncoming traffic alert information carrying the oncoming traffic alert location and oncoming traffic warning message is sent to a client device associated with the target vehicle, for the client device of the target vehicle to alert the target vehicle that it will have an oncoming traffic event with an oncoming vehicle at the accident-prone road segment, so that the driver of the target vehicle pays attention to the oncoming vehicle. Because this embodiment predicts vehicle driving trajectories in advance based on real-time driving information of vehicles and information of accident-prone road segments to predict oncoming traffic events in advance, it is possible to provide an oncoming traffic alert in advance to the driver of a target vehicle that is about to have an oncoming traffic event on an accident-prone road segment. Therefore, the effectiveness and timeliness of oncoming traffic alerts are improved, and the risk of oncoming traffic collisions on accident-prone road segments is reduced. In addition, even if there are blind spots on the accident-prone road segment, the solution of this embodiment can still predict vehicles with a possibility of an oncoming traffic event, reducing the risk of collisions with oncoming vehicles due to blind spots during navigation driving.

In a possible embodiment, the method further includes:

determining the accident-prone road segment included in the target road based on information of road segments included in the target road.

In this embodiment, in addition to being configured by expert assessment, the accident-prone road segment can also be screened out through information of road segments. In this embodiment, the information of road segments included in the target road includes any information that can be used to judge the driving risk of a road segment. The information of the road segment can include real-time environmental information and basic attribute information. The real-time environmental information includes: real-time traffic conditions and/or road visibility. The basic attribute information includes: one or a combination of road segment width, road segment curvature, or roadside obstruction condition. The real-time traffic conditions refer to real-time traffic flow information of the road segment, such as congested, clear, etc. The road visibility refers to the maximum distance at which the human eye can identify a target object on the road segment. The road visibility is related to real-time weather, the current time of day (daytime or nighttime), etc. For example, in weather conditions such as fog, smoke, sandstorms, heavy snow, drizzle, etc., visibility is low, and visibility at night is lower than during the day. The roadside obstruction condition refers to whether there are obstructions on both sides of the road segment causing blind spots and information on the size of the blind spot areas.

In this embodiment, a risk assessment can be performed on the road segments included in the target road based on the information of the road segments included in the target road. For example, the risk assessment can be performed according to evaluation criteria such as: the smaller the road segment width, the higher the risk; the larger the road segment curvature, the higher the risk; the lower the road visibility, the higher the risk; the larger the area of the blind spot caused by roadside obstructions, the higher the risk; the worse the traffic conditions, the higher the risk, and so on. In this way, a risk score for the road segments included in the target road can be obtained, and road segments with a risk score greater than a preset threshold can be determined as accident-prone road segments in the target road. Typical accident-prone road segments include turning road segments, narrow road segments, and other road segments where vehicles are prone to straying from their lane.

In this embodiment, a risk assessment model can also be trained, and the trained risk assessment model can be used to score the risk of the road segments in the target road. The input of the risk assessment model is the information of the road segment, and the output of the risk assessment model is the risk score of the road segment. By inputting the information of the road segment into the risk assessment model and executing the risk assessment model, the risk score of the road segment output by the risk assessment model can be obtained. A road segment with a risk score greater than a preset threshold is determined as an accident-prone road segment. Certainly, a classification model can also be trained to classify the road segments included in the target road into two types: accident-prone road segments and normal road segments, based on the information of the road segments included in the target road, thereby obtaining the accident-prone road segments included in the target road, etc. There are multiple ways to determine the accident-prone road segments included in the target road, which will not be exemplified one by one here.

This embodiment can automatically determine the accident-prone road segments included in the target road based on the information of the road segments included in the target road, without requiring manual configuration of accident-prone road segments, thereby reducing labor costs and achieving convenience and speed.

In a possible embodiment, the method further includes:
acquiring historical driving habit information corresponding to the vehicle;
predicting a trajectory of the vehicle when traveling on the accident-prone road segment based at least on the real-time driving information collected before the vehicle enters the accident-prone road segment and the road segment characteristics associated therewith, includes:
predicting the trajectory of the vehicle when traveling on the accident-prone road segment based on the real-time driving information collected before the vehicle enters the accident-prone road segment, the road segment characteristics associated therewith, and the historical driving habit information corresponding to the vehicle.

In this embodiment, to more accurately predict the trajectory of a vehicle when traveling on the accident-prone road segment before it reaches the accident-prone road segment, in addition to considering the real-time driving information of the vehicle and the road segment characteristics, it is also necessary to consider the user's historical driving habit information. The user's historical driving habit information includes information about the user's historical passage through accident-prone road segments, for example, the user's historical driving habit information when passing through curves (such as speed, acceleration, etc.), and the user's historical driving habit information when passing through narrow roads (such as speed, acceleration, etc.).

In a possible embodiment, predicting the trajectory of the vehicle when traveling on the accident-prone road segment based on the real-time driving information collected before the vehicle enters the accident-prone road segment, the road segment characteristics associated therewith, and the historical driving habit information corresponding to the vehicle, includes:

using the real-time driving information collected before the vehicle enters the accident-prone road segment, the road segment characteristics associated therewith, and the historical driving habit information corresponding to the vehicle as input to a pre-trained trajectory prediction model, and the trajectory prediction model outputs the predicted trajectory of the vehicle when traveling on the accident-prone road segment.

In this embodiment, a trajectory prediction model can be pre-trained, and the pre-trained trajectory prediction model is used to predict the trajectory of the vehicle when traveling on the accident-prone road segment. The input of the prediction model is the user's historical driving habit information, the vehicle's real-time driving information, and the road segment characteristics. The output of the prediction model is the trajectory of the vehicle when traveling on the accident-prone road segment.

In this implementation, the trajectory prediction model can be obtained by training with training sample data. The training sample data includes historical driving habit information of sample users, real-time driving information collected when sample users drive sample vehicles to an accident-prone road segment within a historical time period, road segment characteristics, and the actual trajectories of the sample vehicles when traveling on the accident-prone road segment. During training, the historical driving habit information of the sample users in the training sample data, the real-time driving information collected when the sample users drive the sample vehicles to the accident-prone road segment within the historical time period, and the road segment characteristics associated therewith can be input into an initial trajectory prediction model. The model parameters in the trajectory prediction model are continuously adjusted until the accuracy of the trajectory information of the vehicle when traveling on the accident-prone road segment output by the trajectory prediction model reaches a predetermined threshold, such as 97%, when compared with the actual trajectory information of the sample vehicle when traveling on the accident-prone road segment. In this way, the pre-trained trajectory prediction model can be obtained.

In a possible embodiment, determining, based on the trajectories of the vehicles traveling in different traffic directions on the accident-prone road segment, a target vehicle that will have an oncoming traffic event on the accident-prone road segment and an oncoming traffic alert location, includes:
determining, based on the trajectories of the vehicles traveling in different traffic directions on the accident-prone road segment, a target vehicle that will have an oncoming traffic event on the accident-prone road segment and an oncoming vehicle that will meet the target vehicle;
determining a predicted encounter point of the target vehicle and the oncoming vehicle based on the trajectory of the target vehicle when traveling on the accident-prone road segment and the trajectory of the oncoming vehicle when traveling on the accident-prone road segment; and
determining an oncoming traffic alert location and oncoming traffic warning message for providing an oncoming traffic alert based on the predicted encounter point of the target vehicle and the oncoming vehicle.

In this embodiment, based on the predicted trajectories of the vehicles traveling in different traffic directions on the accident-prone road segment, it is possible to determine a target vehicle that will have an oncoming traffic event on the accident-prone road segment and an oncoming vehicle that will have an oncoming traffic event with the target vehicle. Further, based on the respective trajectory of the target vehicle and its oncoming vehicle when traveling on the accident-prone road segment, the predicted encounter point of the target vehicle and the oncoming vehicle is calculated. Since the oncoming traffic alert needs to be provided in advance, the oncoming traffic alert location can be determined to be before the predicted encounter point. The oncoming traffic warning message can be generated based on the predicted encounter point to alert that the oncoming traffic event will occur at the predicted encounter point, for example, “Oncoming vehicle ahead in 100 meters” and so on.

In this embodiment, for one target vehicle, it may have oncoming traffic events with multiple oncoming vehicles on an accident-prone road segment. At this time, the oncoming traffic alert location can be determined to be before the first predicted encounter point that is closest to the target vehicle. The oncoming traffic warning message can be for the oncoming vehicle corresponding to the first predicted encounter point, for example, “Will have an oncoming traffic event with an oncoming vehicle at location XX”. The oncoming traffic warning message can also be for multiple oncoming vehicles, for example, “Will successively have oncoming traffic events with N oncoming vehicles after location XX”.

In a possible embodiment, the method further includes:
acquiring a vehicle type of the oncoming vehicle.

The oncoming traffic alert information sent to the client device associated with the target vehicle also includes the vehicle type of the oncoming vehicle.

In this embodiment, the vehicle types of the oncoming vehicles that have an oncoming traffic event with the target vehicle are also different; some are large trucks, and some are small cars. For different vehicle types, the reaction of the driver of the target vehicle is also different. Therefore, the vehicle type of the oncoming vehicle can be carried in the oncoming traffic alert information sent to the client device associated with the target vehicle, to also remind the driver in advance of the vehicle type of the oncoming vehicle they are about to have an oncoming traffic event with, so that the driver can prepare in advance and avoid accidents.

In this embodiment, while acquiring the real-time driving information of vehicles traveling on the target road, the vehicle types of the vehicles traveling on the target road can also be acquired. When determining the oncoming vehicle corresponding to the target vehicle, the vehicle type of the oncoming vehicle can be directly acquired. In this way, when transmitting the oncoming traffic alert information to the client device associated with the target vehicle, the vehicle type of the oncoming vehicle can be carried, to alert the vehicle type of each oncoming vehicle that will have an oncoming traffic event with the target vehicle. Since there may be multiple oncoming vehicles that will have an oncoming traffic event with the target vehicle, in order to distinguish the oncoming vehicles of each vehicle type, the oncoming traffic alert information may also include the real-time location of each oncoming vehicle. This allows the client device of the target vehicle to display the corresponding vehicle type icon at the real-time location of each oncoming vehicle on the navigation screen, providing a clear and accurate alert to the driver of the target vehicle.

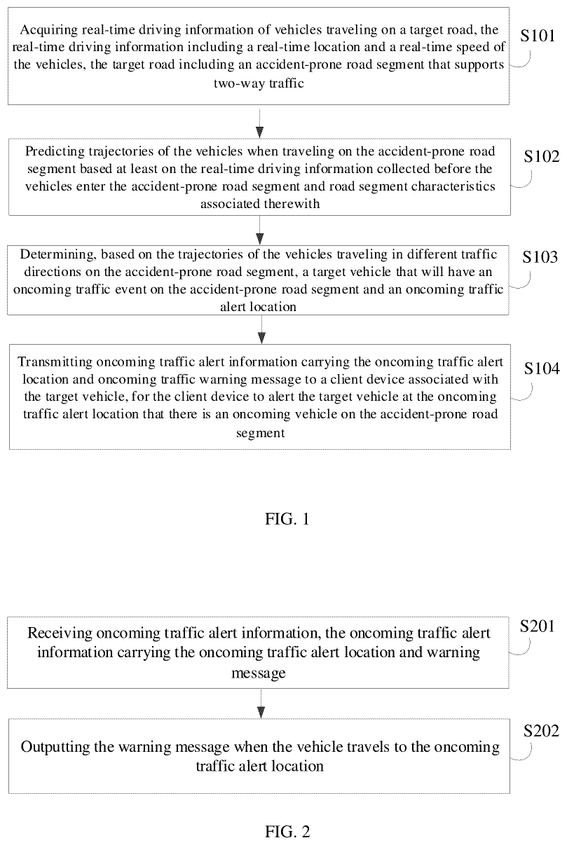

FIG. 2 shows a flowchart of an oncoming traffic alert method according to an embodiment of the present application. As shown in FIG. 2, the oncoming traffic alert method includes the following steps S201-S202:

In step S201, receiving oncoming traffic alert information, the oncoming traffic alert information carrying the oncoming traffic alert location and oncoming traffic warning message.

In step S202, outputting the oncoming traffic warning message when the vehicle travels to the oncoming traffic alert location.

In a possible embodiment, the method for generating oncoming traffic alert information is applicable to a client device associated with an in-vehicle device, a mobile device, or other devices that can execute the generation of oncoming traffic alert information.

In a possible embodiment, when a target vehicle travels near an accident-prone road segment, and a server predicts that it will have an oncoming traffic event with a corresponding oncoming vehicle on the accident-prone road segment, the server will send oncoming traffic alert information carrying an oncoming traffic alert location and oncoming traffic warning message to a client device associated with the target vehicle. After the client device receives the oncoming traffic alert information, it outputs the oncoming traffic warning message when the target vehicle travels to the oncoming traffic alert location. The way the client device outputs the oncoming traffic alert information can be a voice broadcast, such as “Please be aware, there is an oncoming vehicle ahead,” and so on. Alternatively, the output method can also be a screen display, for example, displaying an oncoming traffic icon on the navigation screen in the lane for opposing traffic within the accident-prone road segment.

In this embodiment, when the server predicts that the target vehicle will have an oncoming traffic event with an oncoming vehicle on an accident-prone road segment, it sends oncoming traffic alert information carrying an oncoming traffic alert location and oncoming traffic warning message to the client device associated with the target vehicle. The client device associated with the target vehicle can output the oncoming traffic alert information when the target vehicle travels to the oncoming traffic alert location, alerting the driver of the vehicle that their vehicle will have an oncoming traffic event with an oncoming vehicle at the accident-prone road segment, so that the driver pays attention while driving, avoids collision with the oncoming vehicle, and reduces the probability of an oncoming collision on the accident-prone road segment.

In a possible embodiment, the oncoming traffic alert information also includes a vehicle type and a real-time location of an oncoming vehicle that has an oncoming traffic event with the target vehicle, and the method further includes:

when the target vehicle travels to the oncoming traffic alert location, displaying a vehicle type icon of the oncoming vehicle at the real-time location of the oncoming vehicle on a current navigation screen.

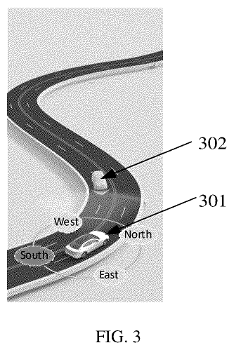

In this embodiment, the oncoming traffic alert information also includes the vehicle type and real-time location of the oncoming vehicle that has an oncoming traffic event with the target vehicle. When outputting the oncoming traffic warning message, the vehicle type and real-time location of the oncoming vehicle that will have an oncoming traffic event with the target vehicle on the accident-prone road segment are also output in real time. For example, FIG. 3 shows a schematic diagram of an oncoming traffic alert output on a navigation screen according to an embodiment of the present application. When broadcasting the oncoming traffic warning message “A small car is approaching from the opposite direction X hundred meters ahead and will have an oncoming traffic event with this vehicle at the curve,” it is also possible, as shown in FIG. 3, to display a vehicle type icon of the oncoming vehicle 302 at the real-time location of the oncoming vehicle 302 on the current navigation screen of the target vehicle 301.

It needs to be noted here that the server will continuously update the real-time location of the oncoming vehicle that will have an oncoming traffic event with the target vehicle at the curve in the oncoming traffic alert information before the oncoming traffic event ends. The client device of the target vehicle will continuously update the real-time location of each oncoming vehicle that will have an oncoming traffic event with the vehicle at the curve based on the updated oncoming traffic alert information.

An embodiment of the present application also discloses a navigation service, wherein oncoming traffic alert information is generated based on the above-described method for generating oncoming traffic alert information, and a navigation alert service for a corresponding scenario is provided to a target vehicle based on the oncoming traffic alert information. In some embodiments, the corresponding scenario is a combination of one or more of AR navigation, elevated road navigation, or main-auxiliary road navigation.

An embodiment of the present application also discloses a navigation method, wherein a navigation route is calculated based on an electronic map, a starting point, an ending point, and traffic conditions. If the navigation route includes an accident-prone road segment, then during the process of navigation guidance based on the navigation route, oncoming traffic alert information is generated based on the above-described method for generating oncoming traffic alert information, and the oncoming traffic alert information is broadcast.

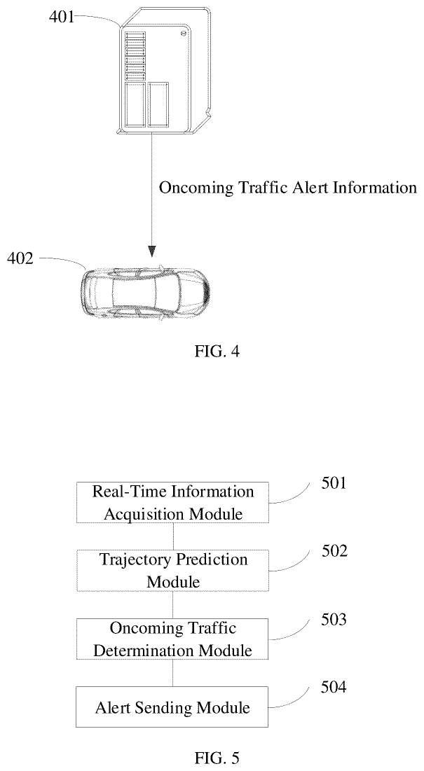

FIG. 4 shows a schematic diagram of an application in a navigation application scenario according to an embodiment of the present application. As shown in FIG. 4, a server 401 can use the above-described method for generating oncoming traffic alert information to send oncoming traffic alert information to the client devices of vehicles that will meet on the accident-prone road segment. The oncoming traffic alert information includes an oncoming traffic alert location, oncoming traffic warning message, and the vehicle type and real-time location of the oncoming vehicle that has an oncoming traffic event with the target vehicle. During the process of navigation guidance based on a navigation route by a client device associated with a target vehicle 402, when the target vehicle travels near the accident-prone road segment, the client device of the target vehicle 402 can receive the oncoming traffic alert information sent by the server 401. The client device of the target vehicle 402 can broadcast the oncoming traffic warning message by voice and display a vehicle type icon of the oncoming vehicle at the real-time location of the oncoming vehicle on the current navigation screen. In this way, the driver of the target vehicle 402 will take precautions against the oncoming vehicle in advance at the accident-prone road segment, avoiding a collision with the oncoming vehicle and reducing the probability of an accident.

FIG. 5 shows a structural block diagram of a device for generating oncoming traffic alert information according to an embodiment of the present application. Wherein, the device can be implemented as part or all of an electronic device through software, hardware, or a combination of both. As shown in FIG. 5, the device for generating oncoming traffic alert information includes:
a real-time information acquisition module 501, configured to acquire real-time driving information of vehicles traveling on a target road, the real-time driving information including a real-time location and a real-time speed of the vehicles, the target road including an accident-prone road segment, and the accident-prone road segment being at least a two-way traffic road segment;
a trajectory prediction module 502, configured to predict trajectories of the vehicles when traveling on the accident-prone road segment, based at least on the real-time driving information collected before the vehicles enter the accident-prone road segment and road segment characteristics associated therewith;
an oncoming traffic determination module 503, configured to determine, based on the trajectories of the vehicles driving in different traffic directions on the accident-prone road segment, a target vehicle that will have an oncoming traffic event on the accident-prone road segment and an oncoming traffic alert location;
an alert transmitting module 504, configured to send oncoming traffic alert information carrying the oncoming traffic alert location and oncoming traffic warning message to a client device associated with the target vehicle, for the client device to alert the target vehicle at the oncoming traffic alert location that there is an oncoming vehicle on the accident-prone road segment.

In a possible embodiment, the device further includes:
an accident segment determination module, configured to determine the accident-prone road segment included in the target road based on information of road segments included in the target road.

In a possible embodiment, the device further includes:
a habit information acquisition module, configured to acquire historical driving habit information corresponding to the vehicles;
the trajectory prediction module is configured to:
predict the trajectories of the vehicles when traveling on the accident-prone road segment, based on the real-time driving information collected before the vehicles enter the accident-prone road segment, the road segment characteristics associated therewith, and the historical driving habit information corresponding to the vehicles.

In a possible embodiment, the prediction of the trajectory information by the trajectory prediction module based on the real-time driving information collected before the vehicles enter the accident-prone road segment, the road segment characteristics associated therewith, and the historical driving habit information corresponding to the vehicles, is configured to:
use the real-time driving information collected before the vehicles enter the accident-prone road segment, the road segment characteristics associated therewith, and the historical driving habit information corresponding to the vehicles as input to a pre-trained trajectory prediction model, and the trajectory prediction model outputs the predicted trajectories of the vehicles when traveling on the accident-prone road segment.

In a possible embodiment, the road segment characteristics include: real-time environmental information and basic attribute information, the real-time environmental information includes: real-time traffic conditions and/or road visibility, and the basic attribute information includes: one or a combination of road segment width, road segment curvature, or roadside obstruction condition.

In a possible embodiment, the oncoming traffic determination module is configured to:
determine, based on the trajectories of the vehicles driving in different traffic directions on the accident-prone road segment, a target vehicle that will have an oncoming traffic event on the accident-prone road segment and an oncoming vehicle that will meet the target vehicle;
determine a predicted encounter point of the target vehicle and the oncoming vehicle based on the trajectory of the target vehicle when traveling on the accident-prone road segment and the trajectory of the oncoming vehicle when traveling on the accident-prone road segment;
determine an oncoming traffic alert location and corresponding oncoming traffic warning message for providing a warning or an alert, based on the predicted encounter point of the target vehicle and the oncoming vehicle.

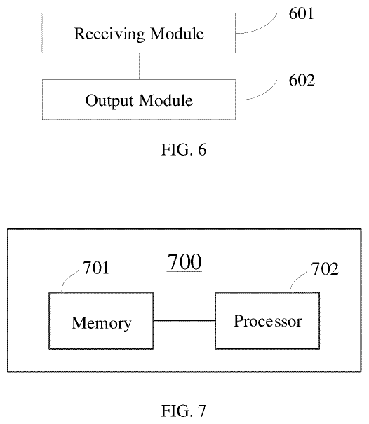

FIG. 6 shows a structural block diagram of an oncoming traffic alert device according to an embodiment of the present application. In particular, the device can be implemented as part or all of an electronic device through software, hardware, or a combination of both. As shown in FIG. 6, the oncoming traffic alert device includes:
a receiving module 601, configured to receive oncoming traffic alert information, the oncoming traffic alert information carrying an oncoming traffic alert location and oncoming traffic warning message;
an output module 602, configured to output the oncoming traffic warning message when a target vehicle travels to the oncoming traffic alert location.

The technical terms and technical features mentioned in this device embodiment are the same as or similar to those in the method embodiments described above. For explanations and descriptions of the technical terms and technical features involved in this device, reference can be made to the explanations and descriptions of the method embodiments above, and details are not repeated here.

The present application also discloses an electronic device. FIG. 7 shows a structural block diagram of the electronic device according to an embodiment of the present application.

As shown in FIG. 7, the electronic device 700 includes a memory 701 and a processor 702, wherein the memory 701 is used for storing one or more computer instructions, and wherein the one or more computer instructions are executed by the processor 702 to implement the method according to the embodiments of the present application.

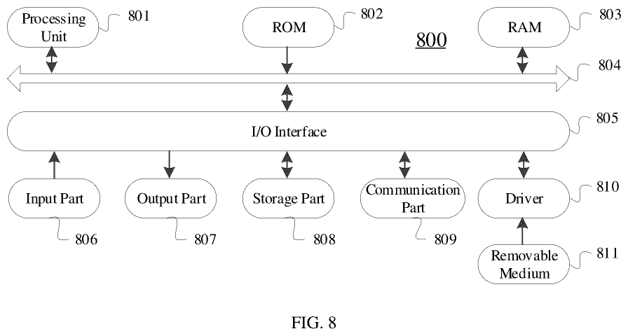

FIG. 8 shows a schematic structural diagram of a computer system suitable for implementing the method according to the embodiments of the present application.

As shown in FIG. 8, a computer system 800 includes a processing unit 801, which can execute various processes in the above embodiments according to a program stored in a read-only memory (ROM) 802 or a program loaded from a storage part 808 into a random-access memory (RAM) 803. In the RAM 803, various programs and data required for the operation of the computer system 800 are also stored. The processing unit 801, the ROM 802, and the RAM 803 are connected to each other through a bus 804. An input/output (I/O) interface 805 is also connected to the bus 804.

The following components are connected to the I/O interface 805: an input part 806 including a keyboard, a mouse, etc.; an output part 807 including a cathode ray tube (CRT), a liquid crystal display (LCD), etc., and a speaker, etc.; a storage part 808 including a hard disk, etc.; and a communication part 809 including a network interface card such as a LAN card, a modem, etc. The communication part 809 performs communication processing via a network such as the Internet. A driver 810 is also connected to the I/O interface 805 as needed. A removable medium 811, such as a magnetic disk, an optical disc, a magneto-optical disc, a semiconductor memory, etc., is installed on the driver 810 as needed, so that a computer program read from it can be installed into the storage part 808 as needed. Wherein, the processing unit 801 can be implemented as a processing unit such as a CPU, GPU, TPU, FPGA, NPU, etc.

In particular, according to the embodiments of the present application, the method described above can be implemented as a computer software program. For example, an embodiment of the present application includes a computer program product, which includes computer instructions that, when executed by a processor, implement the method steps described above. In such an embodiment, the computer program product can be downloaded and installed from a network via the communication part 809, and/or installed from the removable medium 811.

The flowcharts and block diagrams in the accompanying drawings illustrate the possible implementation architecture, functions, and operations of systems, methods, and computer program products according to various embodiments of the present application. In this regard, each block in the flowcharts or block diagrams may represent a module, a program segment, or a part of code, which contains one or more executable instructions for implementing specified logical functions. It should also be noted that in some alternative implementations, the functions noted in the blocks may occur out of the order noted in the drawings. For example, two blocks shown in succession may, in fact, be executed substantially in parallel, or they may sometimes be executed in the reverse order, depending upon the functionality involved. It is also to be noted that each block of the block diagrams and/or flowcharts, and combinations of blocks in the block diagrams and/or flowcharts, can be implemented by special-purpose hardware-based systems that perform the specified functions or operations, or can be implemented by a combination of special-purpose hardware and computer instructions.

The units or modules involved in the embodiments of the present application may be implemented by means of software, or may be implemented by means of programmable hardware. The names of the described units or modules do not, in some cases, constitute a limitation on the unit or module itself.

As another aspect, the present application also provides a computer-readable storage medium, which may be the computer-readable storage medium included in the electronic device or computer system in the above embodiments; it may also be a computer-readable storage medium that exists separately and is not assembled into the device. The computer-readable storage medium stores one or more programs, which are used by one or more processors to execute the method described in the present application.

The above descriptions are only preferred embodiments of the present application and an explanation of the technical principles applied. Those skilled in the art should understand that the scope of the invention involved in the present application is not limited to the technical solutions formed by the specific combination of the above technical features, but should also cover other technical solutions formed by any combination of the above technical features or their equivalent features without departing from the inventive concept. For example, technical solutions formed by substituting the above features with technical features having similar functions disclosed in (but not limited to) the present application.

1. A method for generating oncoming traffic alert information, comprising:
acquiring real-time driving information from one or more vehicles traveling on a target road, wherein the real-time driving information for each vehicle comprises a real-time location and a real-time speed, and wherein the target road includes an accident-prone road segment that supports two-way traffic;
predicting, for each vehicle, a trajectory of the vehicle through the accident-prone road segment, based at least on the real-time driving information collected prior to the vehicle entering the accident-prone road segment and road segment characteristics associated therewith;
determining, based on the predicted trajectories of vehicles traveling in opposite directions along the accident-prone road segment, whether a first vehicle is predicted to encounter an oncoming second vehicle within the accident-prone road segment, and if so, identifying the first vehicle as a target vehicle and determining an oncoming traffic alert location located ahead of a predicted encounter point; and
transmitting, to a client device associated with the target vehicle, oncoming traffic alert information comprising the oncoming traffic alert location and an oncoming traffic warning message, such that the client device issues a warning to a driver of the target vehicle as it approaches the oncoming traffic alert location, indicating the presence of an oncoming vehicle within the accident-prone road segment.

2. The method according to claim 1, wherein the method further comprises:
determining the accident-prone road segment of the target road based on information about road segments included in the target road.

3. The method according to claim 1, wherein the method further comprises:
acquiring historical driving habit information corresponding to each of the one or more vehicles;
wherein predicting, for each vehicle, a trajectory of the vehicle through the accident-prone road segment, based at least on the real-time driving information collected prior to the vehicle entering the accident-prone road segment and road segment characteristics associated therewith, comprises:
predicting, for each vehicle, a trajectory of the vehicle through the accident-prone road segment, based at least on the real-time driving information collected prior to the vehicle entering the accident-prone road segment and road segment characteristics associated therewith, and the historical driving habit information corresponding to the vehicle.

4. The method according to claim 3, wherein predicting, for each vehicle, a trajectory of the vehicle through the accident-prone road segment, based at least on the real-time driving information collected prior to the vehicle entering the accident-prone road segment and road segment characteristics associated therewith, and the historical driving habit information corresponding to the vehicle, comprises:
using the real-time driving information collected prior to the vehicle entering the accident-prone road segment, road segment characteristics associated therewith, and the historical driving habit information corresponding to the vehicle as input to a pre-trained trajectory prediction model, and the trajectory prediction model outputting the predicted trajectory of the vehicle when traveling on the accident-prone road segment.

5. The method according to claim 1, wherein the road segment characteristics comprise: real-time environmental information and basic attribute information, the real-time environmental information comprises: real-time traffic conditions and/or road visibility, and the basic attribute information comprises: one or a combination of a road segment width, a road segment curvature, or a roadside obstruction condition.

6. The method according to claim 1, wherein determining, based on the predicted trajectories of vehicles traveling in opposite directions along the accident-prone road segment, whether a first vehicle is predicted to encounter an oncoming second vehicle within the accident-prone road segment, and if so, identifying the first vehicle as a target vehicle and determining an oncoming traffic alert location located ahead of a predicted encounter point, comprises:
determining the predicted encounter point; and
determining, based on the predicted encounter point, the oncoming traffic alert location.

7. The method according to claim 1, wherein the oncoming traffic warning message comprises a predicted encounter point with the oncoming vehicle.

8. The method according to claim 1, wherein the oncoming traffic warning message comprises predicted encounter points with multiple oncoming vehicles.

9. The method according to claim 1, wherein the oncoming traffic warning message comprises a vehicle type of the oncoming vehicle.

10. An oncoming traffic alert method, comprising:
receiving oncoming traffic alert information, the oncoming traffic alert information carrying an oncoming traffic alert location and oncoming traffic warning message; and
outputting the oncoming traffic warning message when a target vehicle travels to the oncoming traffic alert location.

11. The method according to claim 10, wherein the oncoming traffic warning message comprises a predicted encounter point of the target vehicle with an oncoming vehicle.

12. The method according to claim 11, wherein the predicted encounter point is in an accident-prone road segment.

13. The method according to claim 10, wherein the oncoming traffic warning message comprises predicted encounter points of the target vehicle with multiple oncoming vehicles.

14. The method according to claim 13, wherein the predicted encounter points are in an accident-prone road segment.

15. The method according to claim 10, wherein the oncoming traffic warning message comprises a vehicle type of an oncoming vehicle.

16. The method according to claim 10, wherein the target vehicle is a vehicle that will have an oncoming traffic event on an accident-prone road segment and is determined based on trajectories of one or more vehicles including the target vehicle driving in different traffic directions on the accident-prone road segment.

17. The method according to claim 16, wherein the trajectories of the one or more vehicles is determined based at least on real-time driving information collected before each respective vehicle enters the accident-prone road segment and road segment characteristics associated therewith.

18. The method according to claim 17, wherein the trajectories of the one or more vehicles is determined further based on historical driving habit information of the each respective vehicle.

19. The method according to claim 17, wherein the real-time driving information comprises a real-time location and a real-time speed of the each respective vehicle.

20. An electronic device comprising:
one or more processors; and
one or more computer-readable memories coupled to the one or more processors and having instructions stored thereon that are executable by the one or more processors to perform one or more operations comprising:
acquiring real-time driving information from one or more vehicles traveling on a target road, wherein the real-time driving information for each vehicle comprises a real-time location and a real-time speed, and wherein the target road includes an accident-prone road segment that supports two-way traffic;
predicting, for each vehicle, a trajectory of the vehicle through the accident-prone road segment, based at least on the real-time driving information collected prior to the vehicle entering the accident-prone road segment and road segment characteristics associated therewith;
determining, based on the predicted trajectories of vehicles traveling in opposite directions along the accident-prone road segment, whether a first vehicle is predicted to encounter an oncoming second vehicle within the accident-prone road segment, and if so, identifying the first vehicle as a target vehicle and determining an oncoming traffic alert location located ahead of a predicted encounter point; and
transmitting, to a client device associated with the target vehicle, oncoming traffic alert information comprising the oncoming traffic alert location and an oncoming traffic warning message, such that the client device issues a warning to a driver of the target vehicle as it approaches the oncoming traffic alert location, indicating the presence of an oncoming vehicle within the accident-prone road segment.
